(19) United States
(12) Patent Application Publication
(10) Pub. No.: US 2002/0117165 A1
(43) Pub. Date: Aug. 29, 2002

(54) Grill for cooking food

(76) Inventor: Darryl E. Turner, Atlanta, GA (US)

Correspondence Address: Darryl E. Turner, 824 Cityscape Plaza, Atlanta, GA, 30308, US

(21) Appl. No.: 10/085,325

(22) Filed: Feb. 28, 2002

Related U.S. Application Data
(60) Provisional application No. 60/272,184, filed on Feb. 28, 2001.

(51) Int. Cl. A47J 27/00

(52) U.S. Cl. 126/299 R; 99/444

(57) ABSTRACT

A grill has top and bottom cooking surfaces with the top cooking surface movable upward to load the grill with food and movable downward onto the food and bottom surface to cook the food. Different surface cooking zones may be heated individually to accommodate the amount and type of food. The top surface is lowered and pressed onto the food at a preselected pressure to provide positive contact with the food. Heated marinade and marinade vapor flow through openings or grooves in the cooking surfaces to steam the food and drive fat out for removal to a grease trough. The marinade replaces fat and natural juices producing a relatively low fat cooked meat.

### FIELD OF THE INVENTION

The present invention to a grill for cooking food that is equipped with top and bottom cooking elements movable toward and from one another for cooking food through both sides to reduce cooking time.

### BACKGROUND OF THE INVENTION

Some grills are equipped with top and bottom-heating surfaces so that meat placed between the heating surfaces is cooked from both the top and bottom sides of the meat simultaneously to reduce cooking time. Unfortunately, the cooked meat is often tough because fat contained in the meat has insufficient time to dissolve meat fibers to tenderize the meat. Fat also imports flavor to meat and, when meat is cooked very rapidly, the liquefied fat does not have sufficient time to permeate the meat to develop the full flavor. When these grills cook meat such as hamburger, pork chops, and chicken fillets, they are usually cooked done yielding dry meat, which is tough to chew. Sauces are sometimes applied to the meat after cooking to add moisture and enhance flavor. Unfortunately, applying sauces on top of the meat does not enhance flavor throughout the meat adds very little moisture. It is desirable to have a grill that can cook foods quickly without destroying the flavor or drying out the meat.

Some grills drain fat to a dish to keep it away from the meat during cooking. As the fat is removed from the meat during cooking, the meat dries and flavor is lost. To combat this tendency, meat is sometimes marinated in a mixture of vegetable oil and seasonings that are somewhat absorbed by the meat prior to the cooking which may increase the moisture content and flavor of the cooked meat. Vegetable oil tends to stay on the surface of the meat where it is removed during the cooking process even before the animal fat is rendered liquid and drained from the meat. Marinade is therefore ineffective in reducing the fat content of the cooked meat. The marinade, however, can enhance the flavor of the meat because the spices and other liquids in the marinade are absorbed deeper into the meat than the oil to enhance flavor.

While the marinade can improve the flavor of the cooked meat, its effectiveness is dependent on the liquid in the marinade displacing the liquid in the meat prior to cooking. The displacement process proceeds very slowly at refrigerator temperatures and may take several days for maximum displacement which is impractical in a restaurant setting because of the extra refrigerator space required. The process can be carried out faster at room temperature, but leaving meat at room temperature for the time required for the marinade to be effective gives harmful bacteria a chance to multiply. It is desirable to have a grill that can decrease the fat content of the cooked meat while retaining moisture and flavor without increasing refrigerator space required.

In prior grills the marinade emanates from a cup located in the center of the bottom cooking surface. The marinade flows through the grooves and migrates upward as it evaporates. Moisture from the food vaporizes during cooking and that moisture vaporized by the top cooking surface has a tendency to be forced downward through the food which helps tenderize and flavor the food. Unfortunately, the downward vaporized moisture retards upward movement of the vaporized marinade resulting in less than through penetration of the marinade. It is therefore desirable to have a way to for the marinade to completely penetrate the cooking food to impart uniform flavor and moisture.

When meat is cooked by heating it from the top and bottom simultaneously, rendered fat accumulates on the cooking surfaces of the grill because less evaporates due to the top heating surface. Some grills remove the rendered fat by providing grooves in the cooking surfaces so that the fat can drain into a dish. The grooves in the cooking surface are slanted so that the grease flows by gravity for collection. While this process does remove and capture the rendered fat, it is not practical in a restaurant setting because the rendered fat is hot and therefore hazardous. There is an opportunity for the rendered fat to spill or splatter on a worker and there is the possibility that a worker could be injured by steam exiting through the grooves from the cooking process. It is therefore desirable to have grill where grease is easily captured and removed without exposing workers to it while the meat is cooking. Accordingly, it would be appreciated, that it would be highly desirable to have a grill that captures rendered fat for safe and easy removal.

A problem with grills is that during the cooking process, in addition to fat collecting on the grill, scraps of meat or other cooking debris also accumulate on the cooking surface and must be removed. When left on the cooking surface, the cooking debris will bum importing undesirable flavors to the food that is cooking. It is therefore desirable to have a simple method of removing cooking debris from the surface of the grill after each use.

Another problem with grills is that cleaning the cooking surfaces is difficult. The bottom cooking surface is a horizontal plane at a fixed height that is not comfortable for all workers, while the top cooking surface must be raised over the heads of some workers for cleaning. It is desirable to have cooking surfaces that are easily accessible for all workers.

Still another problem with grills is that vapors and smoke from cooking permeate the air with odors and grease. Vapors and smoke escape from the space existing between the top and bottom cooking surfaces. Even though the top surface overlaps the bottom surface, there is space existing between the two where vapors and smoke escape. It is desirable to have a venting system that discourages smoke and vapors from leaving the grill to permeate the air in the cooking room.

### SUMMARY OF THE INVENTION

According to the present invention, a grill has top and bottom cooking surfaces with the top cooking surface movable upward to load the grill with food and movable downward onto the food and bottom surface to cook the food. Different surface cooking zones may be heated individually to accommodate the amount and type of food. The top surface is lowered and pressed onto the food at a preselected pressure to provide positive contact with the food. Heated marinade and marinade vapor flow through openings or grooves in the cooking surfaces to steam the food and render fat for removal to a grease trough.

It is an object of the invention to provide a grill that can cook foods quickly without destroying the flavor or drying out the meat. This object is achieved by top and bottom cooking surfaces that heat food from the top and bottom simultaneously while steaming the food with its own juices or with a marinade to keep the food moist. It is a feature of the invention that the top and bottom cooking surfaces move, one relative to the other, to contact the food to directly heat the food.

It is an object of the invention to provide a grill that decreases the fat content of the cooked meat while retaining moisture and flavor without increasing refrigerator space required. This object is achieved by forcing steam or marinade through the meat to render the fat and drain the rendered fat as the meat cooks. It is feature of the invention that marinade is added at the time of cooking thereby eliminating the need marinating the meat in a refrigerator. Another feature of the invention is that meat can be cooked from a frozen state without thawing prior to placing it on the grill thereby reducing the need for refrigeration.

Another object of the invention is provide a way to for the marinade to completely penetrate the cooking food to impart uniform flavor and moisture. This object is achieved by introducing the marinade through openings in the top cooking surface. A feature of the invention is a series of passageways and openings in the top member for dispersing the marinade. An advantage of the openings in the top member is that steaming marinade is forced through the meat from both the top and bottom for thorough flavoring and cooking.

Another object of the invention provide a grill that captures rendered fat for safe and easy removal. This object is achieved by a trough along the front edge of the bottom member. A feature of the trough is that it is large enough for collecting cooking debris. An advantage of the trough is that it can be outfitted with a drain to removed grease and debris as it is generated thereby providing a clean working environment at all times and greatly reducing hazards associated with hot grease.

Still another object of the invention provide a simple method of removing cooking debris from the surface of the grill after each use. This object is achieved with tiltable top and bottom cooking surfaces. The rear of the bottom cooking surface can be raised to allow debris and cleaning solution to quickly drain. The top cooking surface pivots from a horizontal position for cooking to a vertical position for cleaning.

Yet another object of the invention is top provide a venting system that discourages smoke and vapors from leaving the grill to permeate the air in the cooking room. This object is achieved by several vent tubes placed about the periphery of the top member of the grill. Individual vent tubes on each side of the grill feed into a larger tube. The four larger tubes feed into a main exhaust tube that has a fan inside to create suction in the several vent tubes. The tubes has some flexibility so that they can flex when the top member moves up and down, and when the top member is tilted for cleaning. A feature of the vent system is that the main exhaust tube can be vented to the outside or vented inside through an activated charcoal filter.

These and other aspect, objects, features and advantages of the present invention will become more apparent from a study of the detailed description of the invention and by reference to the accompanying drawings.

### BRIEF DESCRIPTION OF DRAWINGS

FIG. 1 is a diagrammatic front view of a preferred embodiment of a grill according to the present invention.

FIG. 2 is a diagrammatic right side view of the grill of FIG. 1 with the grill open to receive food to be cooked.

FIG. 3 is a diagrammatic right side view of the bottom portion of the grill with the bottom cooking surface tilted.

FIG. 4 is a diagrammatic right side view of the bottom portion of the grill illustrating the marinade cup and grease through.

FIG. 5 is a diagrammatic top view of the top portion of the grill illustrating the pivot bar.

FIG. 6 is a diagrammatic top view of the bottom cooking surface illustrating the embedded cooking elements.

FIG. 7 is a diagrammatic bottom view of the top cooking surface illustrating the embedded cooking elements.

FIG. 9 illustrates the control panel for the grill.

FIG. 10 is a diagram of a ventilation system for the top member of the grill.

### DETAILED DESCRIPTION OF THE PREFERRED EMBODIMENT

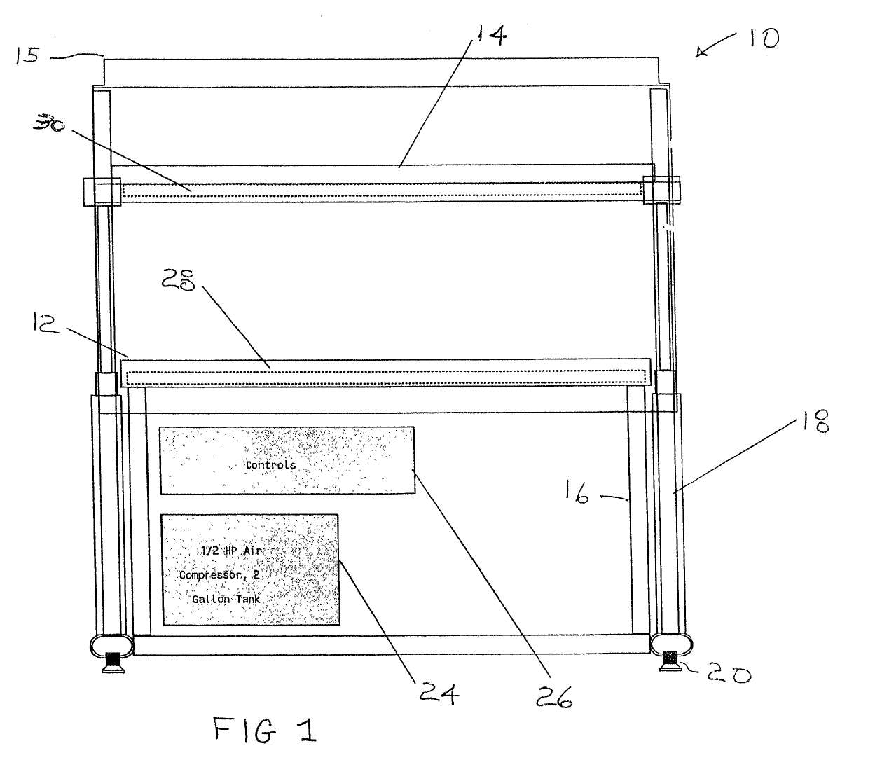

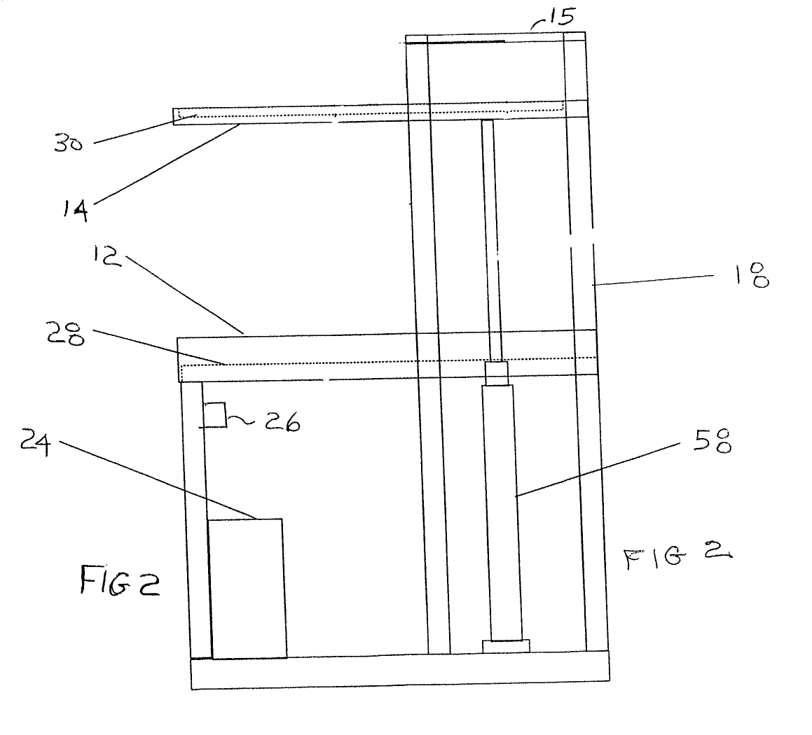

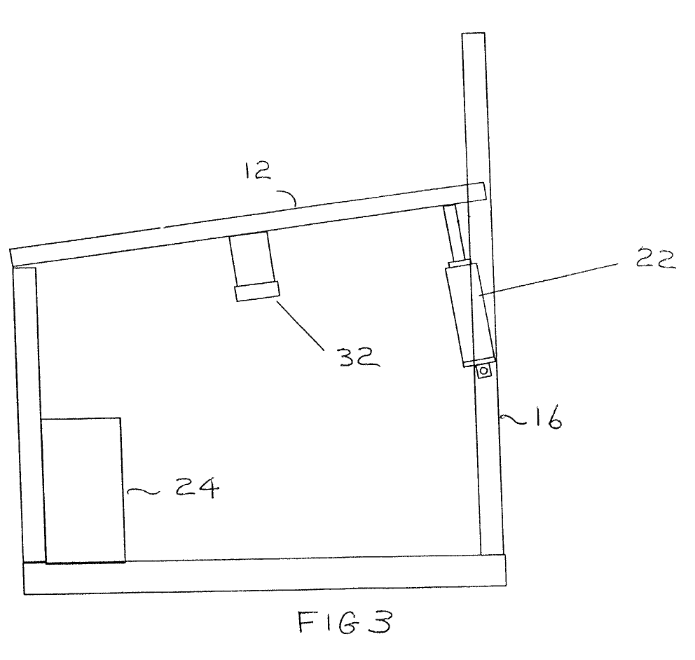

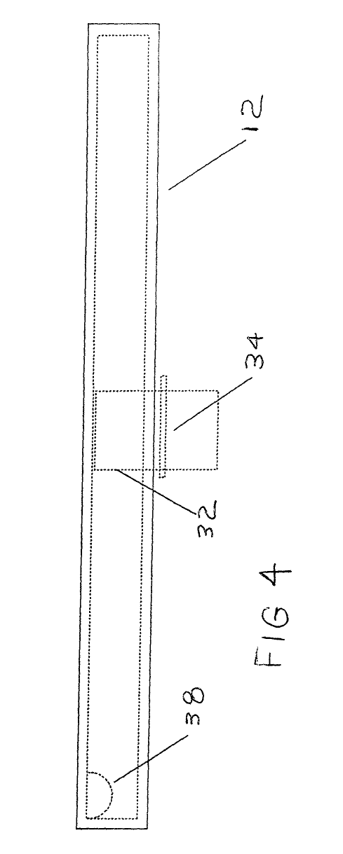

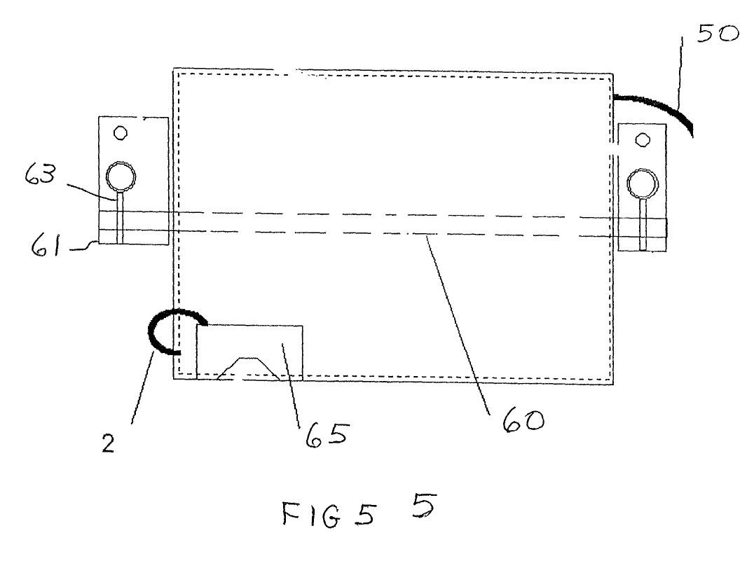

Referring to FIGS. 1-3, a grill 10 for cooking food contains a frame which supports a bottom member 12 and top member 14 each of which contains a cooking surface. The frame preferably has a set of legs 16 for supporting the bottom member 12 and a set of vertically extending, telescoping posts 18 for supporting the top member 14. Preferably, the posts have lockable wheels 20 for moving the grill about, and also have height adjustment and leveling devices. A hood or canopy 15 may be attached at the top of posts 18. Stainless steel is preferred for construction of the grill but other metals can be used that are corrosion resistant and have a clean appearance.

One or more jacks 22 have one end attached to the legs or to a cross member attached to the legs, and has the other end attached to the bottom cooking surface or to a brace or bracket attached to the bottom cooking surface. The jacks 22 operate to raise the back edge of the bottom cooking surface relative to the front edge to cause grease and liquid to drain from the bottom cooking surface. The jacks 22 may be hydraulic with the cylinder end attached to the legs and the piston end attached to the bottom cooking surface. Alternatively, jacks 22 cam be solenoids or electric motors that raise and lower the rear edge of the bottom cooking surface relative to the front edge of the bottom cooking surface. An electric motor could work in conjunction with a gear rack that raises and lowers to operate the bottom cooking surface. Power controls 24 for the jacks 22 a may be located on the frame below the bottom member 12. In the case of hydraulic jacks, controls 24 would include a pump and hoses for supplying pressurized fluid to the jacks along with appropriate manual switches and controls for an operator to turn the pump on or off and to raise or lower the bottom member. A manual control panel 26 for the grill may be located on the frame below the bottom member 12 above the power controls 24 on the left side of the grill. Along its front edge, bottom member 12 is preferably hingedly connected to the frame so that bottom member 12 pivots or partially rotates about the hinged connection point. For efficient cleaning, the rear of the bottom member is raised to encourage grease runoff and to make the rear more accessible to the operator.

Referring to FIGS. 1-6, the bottom member 12 has a bottom periphery bounding the bottom cooking surface 28 that is slightly upturned to prevent liquids on the cooking surface 28 from spilling over the edge of the bottom member. Preferably, bottom cooing surface has a larger area than top cooking surface 30 which allows vapors from cooking escaping from between the cooking surfaces to naturally turn upward instead of being forced outward into the path of an operator.

Bottom cooking surface 28 preferably has a cylindrical marinade cup 32 formed therein for holding a marinade used to moisturize and flavor the food that is cooking. The marinade cup preferably extends below the bottom member 12, has a bottom cap that is removable and has its own heating element 34. It may be fitted with a tube for the introduction of the marinade allowing easy measuring and changing of the mixture according to the food to be cooked. The removable cap can be removed to form a drain that is useful for directing debris and cleaning solutions to a collection station when the bottom surface is cleaned.

The marinade cup 32 maybe a separate cup member positioned in a depression or opening in the bottom cooking surface or it maybe formed from a depression formed in the bottom cooking surface. Preferably, the cup 32 is a threaded member that screws into a threaded opening in the bottom member or screws onto a threaded tail pipe that opens to the bottom cooking surface. The idea is to have a cup that is removable for cleaning and to have a bottom member that is relatively easy to manufacture. As an alternative to threaded members, other methods for coupling members together may be used, such as the couplings used for hydraulic and pneumatic lines which are easy to connect without leaks.

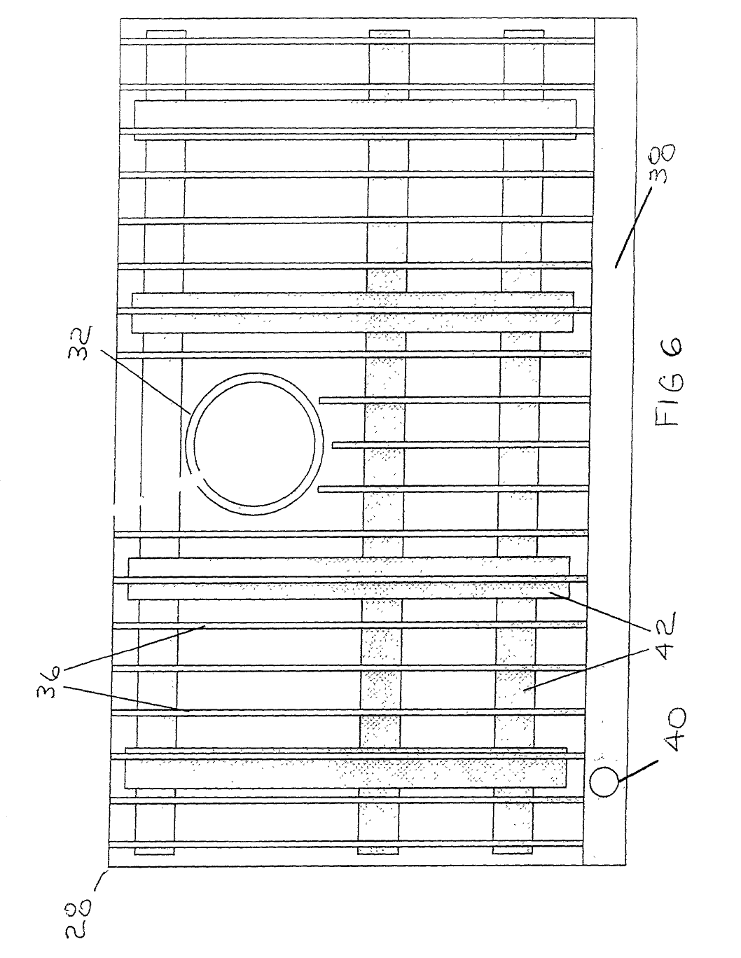

Referring to FIG. 6, the bottom cooking surface 28 contain a plurality of grooves 36 that terminate at a grease collection trough 38. The grooves 36 preferably run laterally from back to front with a varying depth slanting bottom that acts a drain for directing grease collecting in the grooves 36 to the grease collection trough 38. The grease collection trough 38 preferably borders the front of the cooking surface so that grease drains from the cooking surface to the through 38 and is direct ed to a drain 40 that directs the collected grease into a container or grease trap in the plumbing system for the building for appropriate disposal or recycling.

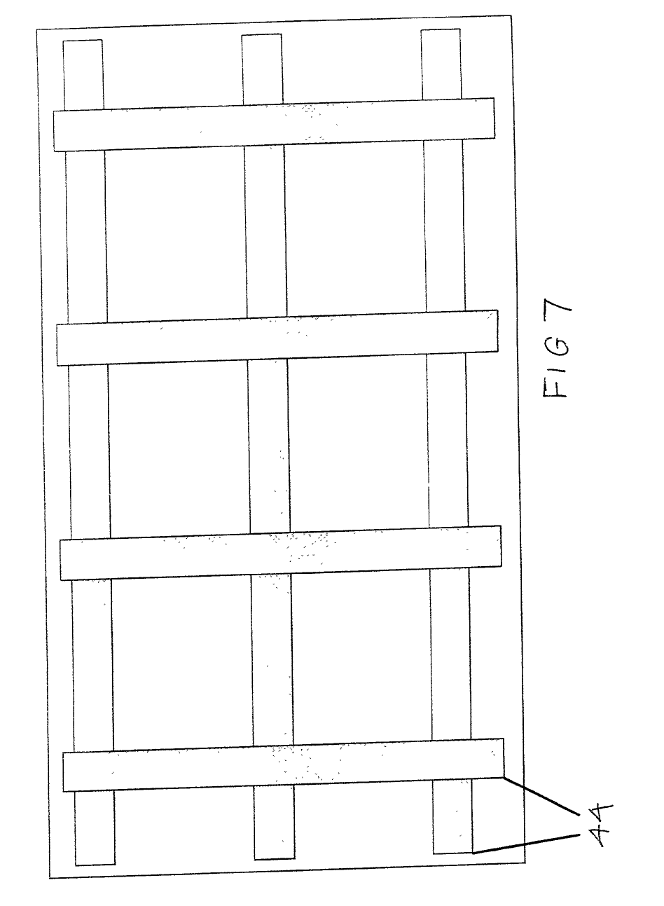

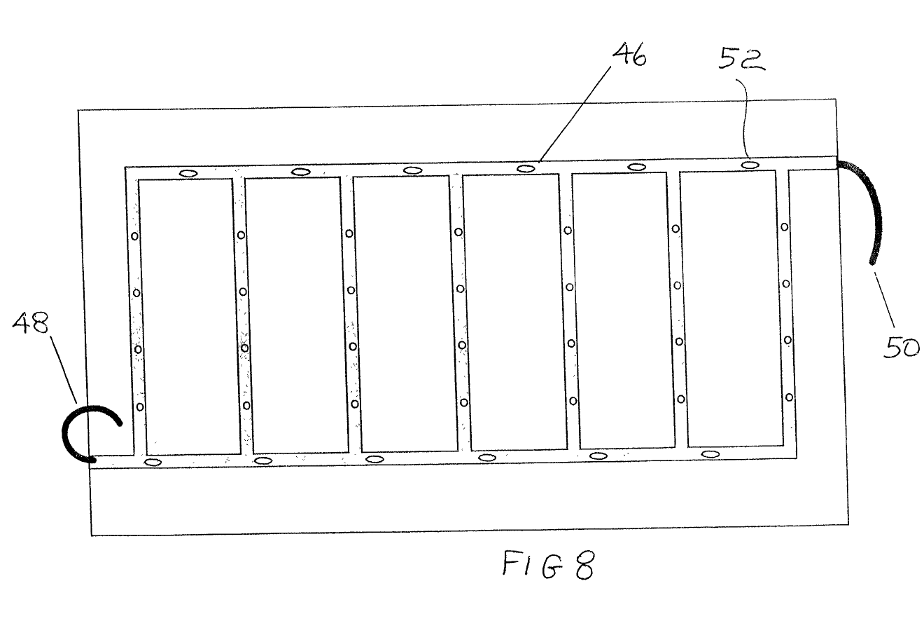

Both the top and bottom cooking surfaces may be heated with heating elements 42, 44 imbedded beneath the cooking surfaces. Such heating elements may be strips of nichrome heater wire or other electrical heating element, or heat tubes for distributing steam, water, air or other fluid for heating. Nichrome wire could be embedded in the channels in the top and bottom members or attached to the rear of the cooking surfaces. Similarly, conduits for fluid could be embedded in the channels in the top and bottom members or attached to the rear of the cooking surfaces. The preferred arrangement for cooking with a filled grill is to have the heaters 42, 44 (FIGS. 6-7) spaced to uniformly heat the entire cooking surface so that food cooks uniformly. To make a single grill more versatile, the cooking surface can be divided into zones with each zone having a heating element 42, 44 to heat a portion of the cooking surface as needed for the particular items to be cooked.

The heaters may be arranged to heat the cooking surface uniformly, and may be controlled from control panel 26 to heat only specific portions or zones of the cooking surface as desired depending on the variety and amount of food to be cooked, or to heat different portions or zones of the grill at different temperatures to cook more than one food at a time. The control panel 26 regulates the temperatures by controlling electric current or heating fluid flow to the top and bottom members. To heat in zones, the wiring or tubing is laid in zones and controlled from control panel 26 accordingly. In the case of heated fluid, a manifold attached to or near the top member with a tube for each zone controlled by a solenoid would effectively control flow to regulate the temperature. While such laying in zones is a more expensive manufacturing process, it is desirable where the grill will be called upon to provide a variety of foods in small servings. Not only may the top and bottom cooking surfaces operate at different temperatures, but different portions of each can be operated at differing desired temperatures for different periods of time. Varying the cooking time by zones or portions of the grill cooking surfaces allows foods to be cooked as desired and takes into account the time required to load and unload the grill so that foods are not inadvertently overcooked.

Referring to FIG. 8, to solve the problem of uneven dispersement of the marinade, the top member is outfitted with a number of jets 46 to spray or drip marinade from the top onto the cooking food. The jets are arranged in zones or other pattern to compliment the heating pattern, and are controlled by a solenoid manifold in similar manner to the heating fluid. The marinade is pumped to the manifold by a pump from a reservoir 65 (FIG. 5) with sufficient pressure for the jets to provide a drip or spray as desired. An inlet tube 48 delivers marinade to the jets, or manifold where a manifold is used, while an outlet tube 50 discharges unused marinade. Outlet tube 50 is preferably fitted with a one way valve 52 to prevent fluid from back flowing. Fluid flows from inlet tube 48 through tubing for jets 46 and on to outlet tube 50. To help build pressure to operate the jets, the one way valve 52 may be a solenoid operated valve. The jets and associated tubing are preferably embedded in the top member. Inlet tube 48 is removably connected to the embedded tubing. One way valve 52 and outlet tube 50 are also removably connected to the embedded tubing. The embedded tubing is easily cleaned by replacing the marinade with a cleaning solution followed by a rinsing solution.

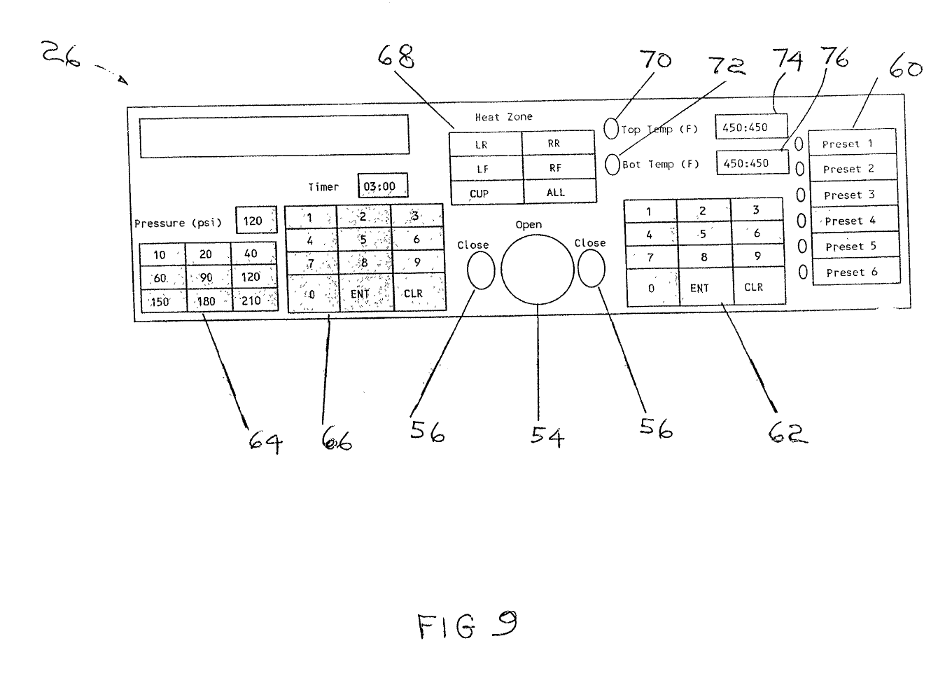

Referring to FIG. 9, while the prior method of introducing marinade through grooves in the bottom member was superior to previous methods of cooking for speed and flavor, it produced a cooked product which was cooked and flavored more on the bottom than throughout the product because of the cooking occurring while loading and unloading the grill. The present method of introducing marinade from both the top and bottom produces a more uniformly flavored product, while the zone, temperature and time controls produce more uniform cooking to compensate for time spent loading and unloading the grill. The control panel 26 contains push buttons or other control mechanisms for opening 54 the grill and for closing 56 the grill. Push buttons 54 and 56 open and close the grill by energizing jack 58 to raise and lower top member 14. Alternatively, the bottom member 12 may be raised to close the grill and lowered to open the grill, but moving the top member up or down is preferred because moving the bottom member would cause the bottom member to be at an inconvenient height when either open or closed thereby increasing operating complexity requiring a worker with increased skill to operate the grill. As the top member is raised and lowered, its telescoping legs extend and retract.

Control panel 26 also has a number of preset buttons 60 which can be programmed for temperature using keypad 62, for pressure using keypad 64, for cooking time using timer keypad 66, and for cooking zone using heat zone keypad 68. Lights 70, 72 illuminate to indicate that the top and bottom cooking surfaces, respectively, are at the desired temperature. Gauges 74 and 76 show top and bottom cooking surface temperatures in actual degrees referenced against the desired temperature. Each preset button 60 has an indicator light associated with it to indicate that the preset is being used. Temperature can be controlled by varying the time the heating elements are energized during the cooking cycle time. Cooking cycle time begins after the desired temperature is initially reach and when the desired pressure is obtained after moving the cooking surfaces towards one another. Cooking time for each particular food requires only a few trials. Cooking times for various foods are provided with instructions for the grill. To prevent over cooking, cooling tubes or passageways can run through the top and bottom members to quickly cool the cooking surfaces using water or a recyclable coolant. While artificially cooling the cooking surfaces increases energy demand, it allows food to remain on the grill while a dish is assembled thereby reducing the total area required to prepare a meal.

Referring to FIG. 5, the top member 14 is pivotally connected to its posts so that it can pivot from a horizontal position for cooking to a vertical or nearly vertical position for cleaning. Such pivotal movement may be facilitated by mounting the top member on a pivot rod 60 or pivot pins. Such a pivot rod 60 could extend through top member 14 and terminate in a bracket 61 on either side of the top member. A locking pin 63 fits through openings in the rod 60 and bracket 61 to lock top member in a horizontal position for cooking, or a vertical position for cleaning. With pin 63 removed, top member 14 can be pivoted manually. Brackets 61 are attached to the telescoping posts. Jacks to raise and lower top member 14 can also be attached to the brackets 61 and to the lower portion of the frame.

As an alternative to jacks, stepping motors may be used to raise and lower the top member. The stepping motors could be mounted on the stationary portion of the posts with gear teeth to engage teeth on the telescoping portion of the posts. Or, stepping motors could be mounted on the brackets supporting the top member and used with stationary posts to raise and lower the top member. Stepping motors have the advantage of being able to control the pressure exerted by the top member on the food. Such pressure could be controlled using the motor torque of motor current which indicates the pressure exerted.

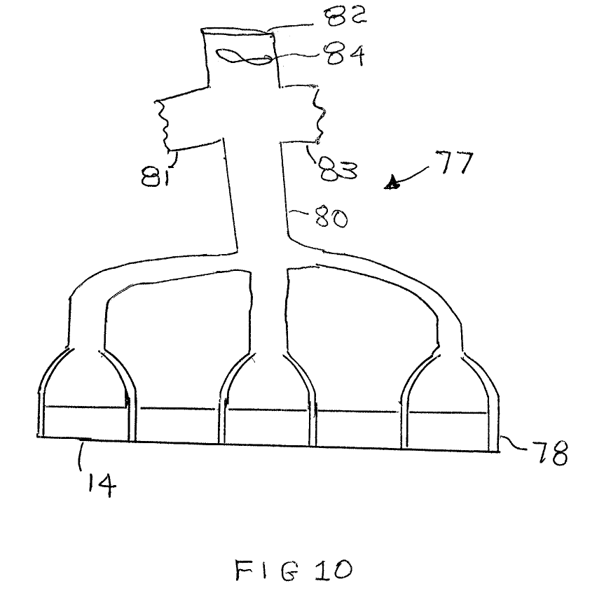

Referring to FIG. 10, an exhaust system 77 is attached about the perimeter of the top member to exhaust smoke and cooking fumes. A series of vent tube 78 are detachably attached to the skirt of the top member 14. Top member 14 is smaller in area than bottom member 12 so that smoke and fumes tend to rise about the periphery of top member 14. The individual vent tubes 78 on each side of the top member connect to larger tubes 80, 81, 83, and a similar tube on the rear (not shown). The larger tubes 80, 81, 83 connect to an exhaust tube 82 that has a fan 84 inside to create suction in vent tubes 78. Tube 82 is preferably vented to the outside but may exhaust into an activated charcoal filter or the like and then recirculated in the room. Tube 80 is flexible to accommodate the up and down motion of top member 14, and to accommodate the pivoting motion of top member 14. Alternatively, or in addition, vent tubes can be added to the bottom member 12, however, top venting is preferred as it takes advantage of the natural tendency of smoke and fumes to rise.

Operation of the present invention results in meat that is moist and tasty. To cook, the top cooking surface is raised, and selections for cooking zone, temperature, pressure and cooking time are selected using the keypads on the control panel. Marinade is added to the reservoir if marinade is to be used. The cooking surfaces and cup are brought to cooking temperature and the meat or other food is placed on the bottom cooking surface. Pushing the “down” button lowers the top surface. Pressure is increased to press the top surface against the food with a preselected pressure. Cooking is accomplished with heat from the top and bottom surfaces and from the heated marinade, marinade vapor and water vapor from the food. After cooking for a prelecteded length of time, the “up” button is pushed to raise the top surface and stop the heating. The food is ready and can be removed from the grill. Where the grill is equipped with a cool down cycle, the food can remain on the grill as platters of food are prepared.

The meat may be seasoned prior to cooking, seasoned with the marinade during cooking, or season as desired after cooking. The vapor injected into the meat during cooking liquefies the fat and replaces the fat which drains away to the collection trough. Meat is placed on the heated grill, and the top cooking surface is lowered and presses on the meat so that the vapor can tenderize it while flavoring it. After a predetermined cooking time, the top cooking surface is raised and the cooked meat is removed. Depending on the particular combination, different meats can be cooked together and vegetables can also be cooked at the same time. Meats using the same marinade can be cooked together although their cooking times may vary. Their cooking temperatures can be varied so that both cook in the same amount of time.

It can now be appreciated that an apparatus and method for cooking food quickly while keeping meat moist and tender has been presented. The apparatus includes a bottom member having a bottom member with a bottom cooking surface, means for controllably heating the bottom cooking surface, a top member with a top cooking surface. The top cooking surface is vertically movable relative to the bottom cooking surface between an open position for loading the apparatus with food to be cooked and a closed position for cooking the food.

The method for cooking food comprises heating the bottom cooking surface of the bottom grill member to a first predetermined temperature and heating a top cooking surface of the top grill member to a predetermined temperature. The temperatures may be the same or different, and different zones of the cooking surfaces may attain different preselected temperatures. If not already raised, the next step is raising the top surface vertically to the open position and loading the bottom cooking surface with food. The food may be pre-seasoned with spices and seasonings, but it is not necessary to do so. The step of adding a marinade of spices, seasonings and juices to the marinade reservoir will cause sufficient seasoning of the food. After loading the grill with food, the top cooking surface is vertically lowered to the closed position. Press cooking requires forcing the top surface down into contact with the food at a pressure sufficient to confine the food between the cooking surfaces so that the fat can be rendered and the marinade permeated throughout the food.

The method includes heating the marinade creating a marinade vapor, driving the marinade and marinade vapor into the food for rupturing bonds between food fibers and permeating the food replacing fat and juices with the marinade, and draining the fat and juices to the grease collection trough. After cooking the food for a predetermined length of time, the top surface is raised to the open position, and the food is removed.

While the invention has been described with particular reference to the preferred embodiments, it will be understood by those skilled in the art that various changes may be made and equivalents may be substituted for elements of the preferred embodiments without departing from invention. For example, pivot pin for the top member that extends the length of the top member can be replaced by a pair of short pins, one on each end. In addition, many modifications may be made to adapt a particular situation and material to a teaching of the invention without departing from the essential teachings of the present invention. As is evident from the foregoing description, certain aspects of the invention are not limited to the particular details of the examples illustrated, and it is therefore contemplated that other modifications and applications will occur to those skilled in the art. For example, the bottom grill member may be movable while the top grill member remains stationary, and the bottom member may be equipped with an exhaust system. It is accordingly intended that the claims shall cover all such modifications and applications as do not depart from the true spirit and scope of the invention.

What is claimed is:

1. An apparatus, comprising a bottom member having a bottom periphery boundin a bottom cooking surfac, said bottom cooking furface having a central opening and a plurality of grooves, said cooking surface member having a grease collection trough connected to said plurality of grooves, with top and bottom cooking surfaces with the top cooking surface moveable upward to load the grill with food and moveable downward onto the food and bottom surface to cook the food. Where heated marinade and marinade vapor flow through openings or grooves in the cooking surfaces to steam the food and render fat for removal to a grease trough. The marinade can be introduced via openings in the top cooking surface. A feature of the invention is a series of passageways and openings in the top member for dispersing the marinade.

2. An apparatus, that captures rendered fat for safe and easy removal. This object is achieved by a trough along the front edge of the bottom member. A feature of the trough is that it is large enough for collecting cooking debris. An advantage of the trough is that it can be outfitted with a drain to removed grease and debris as it is generated thereby providing a clean working environment at all times and greatly reducing hazards associated with hot grease

3. A simple method of removing cooking debris from the surface of the grilll after each use. This object is achieved with tiltable top and bottom cooking surfaces. The rear of the bottom cooking surface can be raised to allow debris and cleaning solution to quickly drain. The top cooking surface pivots from a horizontal position for cooking to a vertical position for cleaning.

4. A venting system that discourages smoke and vapors from leaving the grill to permeate the air in the cooking room. This object is achieved by several vent tubes placed about the periphery of the top member of the grill. Individual vent tubes on each side of the grill feed into a larger tube. The four larger tubes feed into a main exhaust tube that has a fan inside to create suction in the several vent tubes. The tubes have some flexibility so that they can flex when the top member moves up and down, and when the top member is tilted for cleaning. A feature of the vent system is that the main exhaust tube can be vented to the outside or vented inside through an activated charcoal filter.
